(19) United States
(12) Patent Application Publication
(10) Pub. No.: US 2020/0306747 A1
(43) Pub. Date: Oct. 1, 2020

(54) SAMPLE ANALYSIS CHIP AND FABRICATING METHOD THEREOF

(71) Applicants: BEIJING BOE OPTOELECTRONICS TECHNOLOGY CO., LTD., Beijing (CN); BOE Technology Group Co., Ltd., Beijing (CN)

(72) Inventors: Shuo Tong, Beijing (CN); Kun Liu, Beijing (CN)

(73) Assignees: BEIJING BOE OPTOELECTRONICS TECHNOLOGY CO., LTD., Beijing (CN); BOE Technology Group Co., Ltd., Beijing (CN)

(21) Appl. No.: 16/464,015

(22) PCT Filed: Jun. 26, 2018
(86) PCT No.: PCT/CN2018/092795

§ 371 Date: May 24, 2019

(51) Int. Cl. B01L 3/00

(52) U.S. Cl. CPC B01L 3/508; B01L 2200/12; B01L 2300/12; B01L 2300/0645

(57) ABSTRACT

The present application provides a sample analysis chip. The sample analysis chip includes a base substrate and a working electrode. The working electrode has a double-layer structure. The double-layer structure includes a first electrode layer on the base substrate, and a second electrode layer on a side of th4e first electrode layer facing away the base substrate. The second electrode layer includes a corrosion-resistant, non-metal conductive material. A material of the first electrode layer and a material of the second electrode layer are different from each other.

### TECHNICAL FIELD

The present invention relates to the field of assay equipment technology, more particularly, to a sample analysis chip and a method of fabricating a sample analysis chip.

### BACKGROUND

A wide variety of assay formats have been developed for detecting a target molecule or a signal in a fluid sample. Examples of fluid sample assay chips include flow-cell chips with nano-wells, flow-cell chips without nano-wells, and EFIRM biopsy assay chips. Electrodes in these assay chips are typically made of precious metals such as gold, the fabricating costs are relatively high.

### SUMMARY

In one aspect the present invention provides a sample analysis chip comprising a base substrate; and a working electrode; wherein the working electrode has a double-layer structure; wherein the double-layer structure comprises a first electrode layer on the base substrate, and a second electrode layer on a side of the first electrode layer facing away the base substrate; wherein the second electrode layer comprises a corrosion-resistant, non-metal conductive material, and wherein a material of the first electrode layer and a material of the second electrode layer are different from each other.

Optionally, an orthographic projection of the second electrode layer on the base substrate substantially coves an orthographic projection of the first electrode layer on the base substrate.

Optionally, the material of the second electrode layer comprises a semiconductor material.

Optionally, the material of the first electrode layer comprises a semiconductor material.

Optionally, the sample analysis chip further comprises a protective layer between the first electrode layer and the second electrode layer.

Optionally, the first electrode layer are electrically connected to the second electrode layer through a first via extending through the protective layer.

Optionally, the second electrode layer comprises an acid-resistant conductive semiconductor material.

Optionally, the second electrode layer comprises an N+ doped semiconductor material.

Optionally, the first electrode layer comprises a metal oxide material.

Optionally, the first electrode layer comprises indium tin oxide, and the second electrode layer composes an N+ doped silicon.

Optionally, the sample analysis chip further comprises a recess-forming layer on a side of the second electrode layer facing away the first electrode layer, wherein the sample analysis chip has a plurality of recesses extending through the recess-forming layer, each of which exposing at least a portion of the second electrode layer, and each of the plurality of recesses is configured to hold an analyte.

Optionally, the sample analysts chip farther comprises a conductive polymer layer at least partially covering a surface of the second electrode layer.

Optionally, the sample analysis chip further comprises a plurality of first signal lines and a plurality of first contact pads; wherein one of the plurality of first signal lines electrically connects the working electrode to one of the plurality of first contact pads.

Optionally, the plurality of first signal lines and the first electrode layer are in a same layer and comprise a same material.

Optionally, the sample analysis chip further comprises a counter electrode; wherein the counter electrode has the double-layer structure.

Optionally, the sample analysis chip further comprises a reference electrode; wherein the reference electrode has the double-layer structure.

Optionally, the sample analysis chip further comprises a counter electrode and a reference electrode; wherein the counter electrode has the double-layer structure; the reference electrode has the double-layer structure; and the working electrode is between the reference electrode and the counter electrode, with the reference electrode spaced apart from the working electrode, and the counter electrode spaced apart from the working electrode.

Optionally, the sample analysis chip further comprises a plurality of first signal lines, a plurality of first contact pads; a plurality of second signal lines; a plurality of second contact pads; a plurality of third signal lines; and a plurality of third contact pads; wherein one of the plurality of first signal lines electrically connects the working electrode to one of the plurality of first contact pads; one of the plurality of second signal lines electrically connects the counter electrode to one of the plurality of second contact pads; and one of the plurality of third signal lines electrically connects the reference electrode to one of the plurality of third contact pads.

Optionally, the plurality of first signal lines, the plurality of second signal lines, the plurality of third signal lines, and the first electrode layer are in a same layer and comprise a same material.

In another aspect the present invention provides a method of fabricating a sample analysis chip, comprising framing a working electrode on a base substrate, wherein the working electrode is framed to have a double-layer structure; wherein the double-layer structure is formed to have a first electrode layer on a base substrate, and a second electrode layer on a side of the first electrode layer facing away the base substrate; wherein the second electrode layer is made of a corrosion-resistant, non-metal conductive material; and a material of the first electrode layer and a material of the second electrode layer are different from each other.

### BRIEF DESCRIPTION OF THE FIGURES

The following drawings are merely examples for illustrative purposes according to various disclosed embodiments and are not intended to limit the scope of the present invention.

FIG. 1A is a cross-sectional new of a sample analysis chip in some embodiments according to the present disclosure.

FIG. 1B is a cross-sectional view of a sample analysis chip in some embodiments according to the present disclosure.

FIG. 2 is a plan view of a sample analysis chip in some embodiments according to the present disclosure.

FIG. 3 is a cress-sectional view of a sample analysis chip in some embodiments according to the present disclosure.

FIG. 4 is a cross-sectional view of a sample analysis chip in some embodiments according to the present disclosure.

FIG. 5 is a cross-sectional view of a sample analysis chip in some embodiments according to the present disclosure.

FIG. 6 is a cross-sectional view of a sample analysis chip in some embodiments according to the present disclosure.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

In conventional assay chips, the electrodes are typically made of a metal material that is prone to corrosion due to chemicals in the fluid sample or in the assay reagents. The corrosion on the electrodes results in abnormal detection signal, affecting the sensitivity of the sensor.

Accordingly, the present disclosure provides, inter alia, a sample analysis chip and a method of fabricating a sample analysis chip that substantially obviate one or more of the problems due to limitations and disadvantages of the related art. In one aspect, the present disclosure provides a sample analysis chip. In some embodiments, the sample analysis chip includes a base substrate and a working electrode. Optionally, the working electrode has a double-layer structure. Optionally, the double-layer structure includes a first electrode layer on the base substrate, and a second electrode layer on a side of the first electrode layer facing away the base substrate. Optionally, the second electrode layer includes a common-resistant, non-metal conductive material. Optionally, a material of the first electrode layer and a material of the second electrode layer are different from each other.

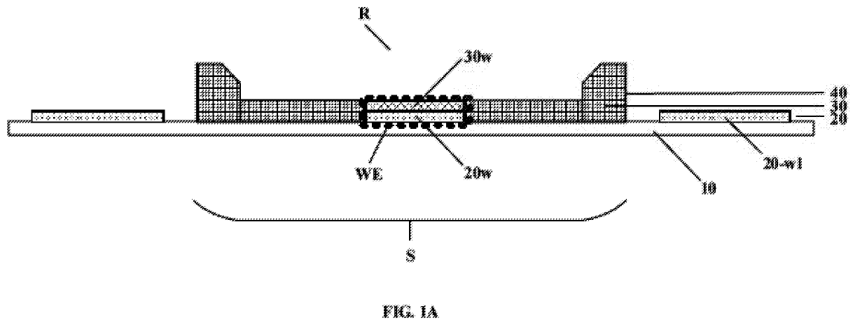

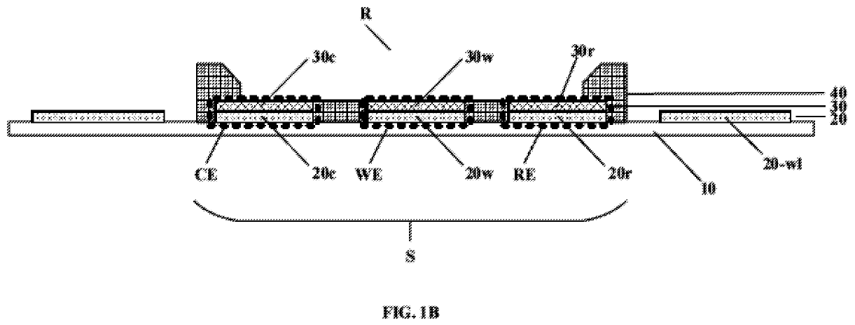

FIG. 1A is a cross-sectional view of a sample analysis chip in some embodiment according to the present disclosure. Referring to FIG. 1A, the sample analysis chip in some embodiments includes a base substrate 10 and a working electrode WE on the base substrate 10. The working electrode WE has a double-layer structure. The double-layer structure includes a first electrode layer 20 on the base substrate 10, and a second electrode layer 30 on a side of the first electrode layer 20 facing away the base substrate 10. The sample analysis chip has a plurality of recesses R configured to hold an analyte (e.g., a sample such as a fluid sample). Optionally, the first electrode layer 20 includes a plurality of first electrode blocks 20w; and the second electrode layer 30 includes a plurality of second electrode blocks 30w. In the present sample analysis chip, the second electrode layer 30 includes a corrosion-resistant, non-metal conductive material. As used herein the term “corrosion-resistant” refers to chemically substantially unreactive in the presence of a corrosive material. Optionally, the corrosion-resistant material is chemically substantially unreactive to an acidic solution. Optionally, the corrosion-resistant material is chemically substantially unreactive to an alkaline solution. Optionally, the corrosion-resistant material is chemically substantially unreactive to an acidic solution and chemically substantially unreactive to an alkaline solution.

In some embodiments, the sample analysis chip includes a base substrate; a first electrode layer on the base substrate and including a plurality of first electrode blocks; a second electrode layer on a side of the first electrode layer facing away the base substrate, and including a plurality of second electrode blocks. The sample analysis chip includes a plurality of sensors. Each of the plurality of sensors includes a working electrode. Optionally, the second electrode layer includes a corrosion-resistant, non-metal conductive material. Optionally, the working electrode includes one of the plurality of first electrode blocks and one of the plurality of second electrode blocks electrically connected to each other. As used herein, the farm “sample” refers to any composition or mixture in which a target analyte of interest may be present, including plant or animal materials, waste materials, materials for forensic analysis, environmental samples, and the like. Optionally, the sample is a biological sample. A biological sample includes any tissue, cell, or extract derived from a living or dead organism which may contain a target analyte (e.g., a target nucleic acid), e.g., peripheral blood, bone marrow, plasma serum biopsy tissue including lymph nodes, respiratory tissue or exudates, gastrointestinal tissue, urine, feces, semen, or other body fluids. Examples of samples of interest further include tissue samples (including body fluids) from a human or an annual particularly ones having or suspected of having a disease or condition. Other samples of interest include industrial samples, such as for water testing, food testing, contamination control, and the like. Optionally, the sample is a fluid sample. Examples of fluid samples include any biological fluid such as saliva, urine blood, placenta, tears, plasma, cerebrospinal fluid, amniotic fluid, breast milk, and serum. As used herein, the terms “analyte” refers to any chemical or biological substance that is measured quantitatively or qualitatively and can include small molecules, proteins, peptides, ammo acids, haptens, antibodies, antigenic substances, DNA, RNA, nucleic acids, nucleotides, drugs, ions, salts, cells, virus components or intact viruses, bacteria components or intact bacteria, cellular components or intact cells, and complexes and derivatives thereof.

In some embodiments, the fluid sample analysis chip further includes a counter electrode. Optionally, the counter electrode has the double-layer structure described herein. Optionally, the double-layer structure includes a first electrode layer on the base substrate, and a second electrode layer on a side of the first electrode layer facing away the base substrate. Optionally, the second electrode layer includes a corrosion-resistant, non-metal conductive material. Optionally, a material of the first electrode layer and a material of the second electrode layer are different from each other.

In some embodiments, the fluid sample analysis chip further includes a reference electrode. Optionally, the reference electrode has the double-layer structure described herein. Optionally, the double-layer structure includes a first electrode layer on the base substrate, and a second electrode layer on a side of the first electrode layer facing away the base substrate. Optionally, the second electrode layer includes a corrosion-resistant, non-metal conductive material. Optionally, a material of the first electrode layer and a material of the second electrode layer are different from each other.

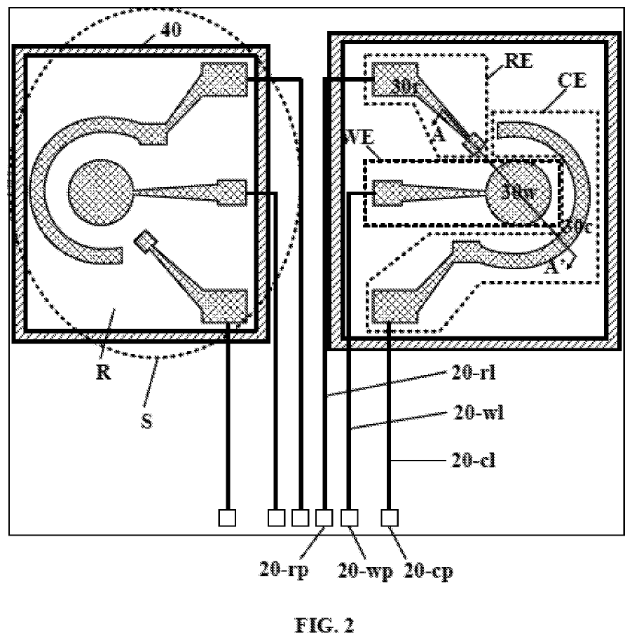

FIG. 1B is a cross-sectional view of a fluid sample analysis chip in some embodiments according to the present disclosure. FIG. 2 is a plan view of a fluid sample analysis chip in some embodiments according to the present disclosure. Referring to FIG. 1B and FIG. 2, the fluid sample analysis chip in some embodiments includes a base substrate 10, a first electrode layer 20 on the base substrate 10, and a second electrode layer 30 on a side of the first electrode layer 20 facing away the base substrate 10. The fluid sample analysis chip has a plurality of recesses R configured to hold an analyte (e.g., a fluid sample). Optionally, the first electrode layer 20 includes a plurality of first electrode blocks 20w, and the second electrode layer 30 includes a plurality of second electrode blocks 30w. Optionally, the first electrode layer 20 includes a plurality of first electrode blocks 20w, a plurality of third electrode blocks 20c, and a plurality of fifth electrode blocks 20r. Optionally, the second electrode layer 30 includes a plurality of second electrode blocks 30w, a plurality of fourth electrode blocks 30c, and a plurality of sixth electrode blocks 30r. In the present fluid sample analysis chip, the second electrode layer 30 includes a corrosion-resistant, non-metal conductive material. As used herein the term “corrosion-resistant” refers to chemically substantially unreactive in the presence of a corrosive material. Optionally, the corrosion-resistant material is chemically substantially unreactive to an acidic solution. Optionally, the corrosion-resistant material is chemically substantially unreactive to an alkaline solution. Optionally, the corrosion-resistant material is chemically substantially unreactive to an acidic solution and chemically substantially unreactive to an alkaline solution.

In some embodiments, the fluid sample analysis chip includes a plurality of sensors S for assaying a liquid sample. Each of the plurality of sensors S includes a working electrode WE. The working electrode WE includes one of the plurality of first electrode blocks 20w and one of the plurality of second electrode blocks 30w electrically connected to each other. As used herein, the term “working electrode” refers to an electrode at which the analyte, or a compound whose level depends on the level of the analyte, is electro-oxidized or electro-reduced with or without the agency of an electron transfer agent. The working electrode is the electrode through which elections from a candidate compound enter a biosensor. Optionally, in a potentiostatic mode, the working electrode is the electrode at which the potential is controlled and the current is measured. Optionally, in a galvanostatic mode, the working electrode is the electrode at which the current is controlled and the potential or voltage is measured.

Optionally, each of the plurality of sensors S includes a working electrode WE, a counter electrode CE, and a reference electrode RE. As used herein, the term “counter electrode” refers to at least one electrode that is paired with a working electrode WE and through which passes an electrochemical current. In general, the counter electrode CE is a conductor that completes the electrochemical cell or circuit. The current that flows into the electrically conductive solution via the working electrode WE leaves the solution via the counter electrode CE. The term “counter electrode” encompasses a counter electrode that also functions as reference electrode (i.e., a counter/reference electrode), unless the description provides that a “counter electrode” excludes a counter/reference electrode.

Optionally, the counter electrode CE includes one of the plurality of third electrode blocks 20c. Optionally, the counter electrode CE includes one of the plurality of third electrode blocks 20c and one of the plurality of fourth electrode blocks 30c electrically connected to each other.

Optionally, each of the plurality of sensors S includes a working electrode WE, a counter electrode CE, and a reference electrode RE. As used herein, the term “reference electrode” refers to at least one electrode that is used as a reference against which the working electrode potential is assessed or measured. The reference electrode may be, and ideally is, non-polarizable, or has a constant and known electrode potential even if current flows through it. The term “reference electrode” encompasses a reference electrode that also functions as a counter electrode (i.e., a center reference electrode), unless the description provides that a “reference electrode” excludes a counter reference electrode.

Optionally, the reference electrode RE includes one of the plurality of fifth electrode blocks 20r. Optionally, the reference electrode RE includes one of the plurality of fifth electrode blocks 20r and one of the plurality of sixth electrode blocks 30r electrically connected to each other.

Optionally, and referring to FIG. 2, the working electrode WE is between the reference electrode RE and the counter electrode CE, with the reference electrode RE spaced apart from the working electrode WE, and the counter electrode CE spaced apart from the working electrode WE.

Optionally, the working electrode WE has a largest dimension in a range of approximately 1 μm to approximately 20 mm, e.g., approximately 1 μm to approximately 2 μm, approximately 2 μm to approximately 5 μm, approximately 5 μm to approximately 10 μm, approximately 10 μm to approximately 25 μm approximately 25 μm to approximately 50 μm, approximately 50 μm to approximately 75 μm, approximately 75 μm to approximately 100 μm, approximately 100 μm to approximately 500 μm, approximately 500 μm to approximately 1 mm, approximately 1 mm to approximately 2 mm, approximately 2 mm to approximately 5 mm, approximately 5 mm to approximately 10 mm, approximately 10 mm to approximately 15 mm, and approximately 15 mm to approximately 20 mm.

Optionally, the counter electrode CE has a largest dimension in a range of approximately 1 μm to approximately 10 mm, e.g., approximately 1 82 m to approximately 2 μm, approximately 2 μm to approximately 5 μm, approximately 5 μm to approximately 10 μm, approximately 10 μm to approximately 25 μm, approximately 25 μm to approximately 50 μm, approximately 50 μm to approximately 75 μm, approximately 75 μm to approximately 100 μm, approximately 100 μm to approximately 500 μm, approximately 500 μm to approximately 1 mm, approximately 1 mm to approximately 2 mm, approximately 2 mm to approximately 5 mm, and approximately 5 mm to approximately 10 mm.

Optionally, the reference electrode RE has a largest dimension in a range of approximately 1 μm to approximately 10 mm, e.g., approximately 1 μm to approximately 2 μm, approximately 2 μm to approximately 5 μm, approximately 5 μm to approximately 10 μm, approximately 10 μm to approximately 25 μm, approximately 25 μm to approximately 50 μm, approximately 50 μm to approximately 75 μm, approximately 75 μm to approximately 100 μm approximately 100 μm to approximately 500 μm, approximately 500 μm to approximately 1 mm, approximately 1 mm to approximately 2 mm, approximately 2 mm to approximately 5 mm, and approximately 5 mm to approximately 10 mm.

Optionally, a gap between the reference electrode RE and the working electrode WE, or a gap between the counter electrode CE and the working electrode WE, has a dimension in a range of approximately 0.1 μm to approximately 5 mm, e.g., approximately 0.1 μm to approximately 0.2 μm, approximately 0.2 μm to approximately 0.5 μm, approximately 0.5 μm to approximately 0.75 μm, approximately 0.75 μm to approximately 1 μm, approximately 1 μm to approximately 2 μm, approximately 2 μm to approximately 5 μm, approximately 5 μm to approximately 10 μm, approximately 10 μm to approximately 25 μm, approximately 25 μm to approximately 50 μm approximately 50 μm to approximately 75 μm, approximately 75 μm to approximately 100 μm, approximately 100 μm to approximately 500 μm, approximately 500 μm to approximately 1 mm, approximately 1 mm to approximately 2 mm, and approximately 2 mm to approximately 5 mm.

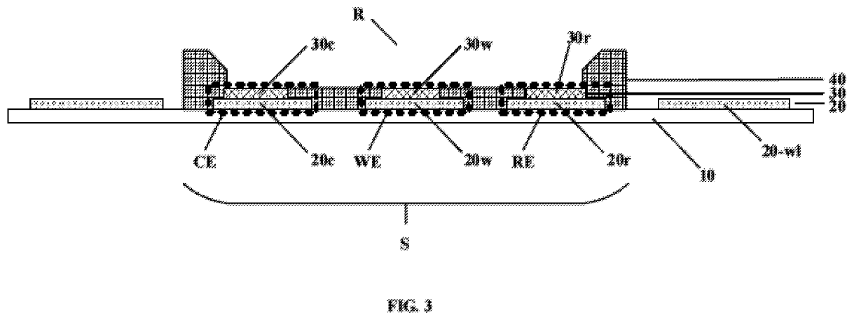

FIG. 3 is a cross-sectional view of a fluid sample analysis chip in some embodiments according to the present disclosure (along A-A′ line in FIG. 2). Referring to FIG. 2 and FIG. 3, the fluid sample analysis chip in some embodiments further includes a recess-forming layer 40 on a side of the second electrode layer 30 facing away the first electrode layer 20. The fluid sample analysis chip has a plurality of recesses R extending through the recess-forming layer 40, exposing at least a portion of each of the plurality of second electrode blocks 30w. Optionally, the plurality of recesses R expose at least a portion of each of the plurality of second electrode blocks 30w, at least a portion of each of the plurality of fourth electrode blocks 30c, and at least a portion of each of the plurality of sixth electrode blocks 30r (as shown in FIG. 2 and FIG. 3). Each of the plurality of recesses R is configured to hold an analyte (e.g., a fluid sample).

In some embodiment, a surface of any of the plurality of first electrode blocks 20w is substantially unexposed, e.g., covered by another layer. By having this design, the plurality of first electrode blocks 20w can be made of any highly conductive material which may or may not be corrosion-resistant. Because the surfaces of the plurality of first electrode blocks 20w are substantially unexposed, corrosive environment does not present an issue to the plurality of first electrode blocks 20w. Various appropriate structures may be implemented in the fluid sample analysis chip to cover the surfaces of the plurality of first electrode blocks 20w.

Referring to FIG. 1B, the surface of the plurality of first electrode blocks 20w facing away the base substrate 10 is substantially covered by the second electrode layer 30. Optionally, a surface of the plurality of third electrode blocks 20c facing away the base substrate 10 is substantially covered by the second electrode layer 30. Optionally, a surface of the plurality of fifth electrode blocks 20r facing away the base substrate 10 is substantially covered by the second electrode layer 30. Optionally, an orthographic projection of the second electrode layer 30 on the base substrate 10 substantially covers an orthographic projection of the first electrode layer 20 on the base substrate 10. Optionally, an orthographic projection of one of the plurality of second electrode blocks 30w on the base substrate 10 substantially covers an orthographic projection of one of the plurality of first electrode blocks 20w on the base substrate 10. Optionally, an orthographic projection of one of the plurality of fourth electrode blocks 30c on the base substrate 10 substantially covers an orthographic projection of one of the plurality of third electrode blocks 20c on the base substrate 10. Optionally, an orthographic projection of one of the plurality of sixth electrode blocks 30r on the base substrate 10 substantially covers an orthographic projection of case of the plurality of fifth electrode blocks 20r on the base substrate 10. As used herein, the term “substantially covers” refers to one orthographic projection being at least 50%, at least 60%, at least 70%, at least 80%, at least 90%, at least 95%, at least 99%, or 100% covered by another orthographic projection.

Referring to FIG. 3, the surface of the plurality of first electrode blocks 20w facing away the base substrate 10 is partially covered by the second electrode layer 30 and partially covered by the recess-forming layer 40. Optionally, a surface of the plurality of third electrode blocks 20c facing away the base substrate 10 is partially covered by the second electrode layer 30 and partially covered by the recess-forming layer 40. Optionally, a surface of the plurality of fifth electrode blocks 20r facing away the base substrate 10 is partially covered by the second electrode layer 30 and partially covered by the recess-forming layer 40. Optionally, a combination of an orthographic projection of the recess-forming layer 40 on the base substrate 10 and an orthographic projection of the second electrode layer 30 on the base substrate 10 substantially covers an orthographic projection of the first electrode layer 20 on the base substrate 10. Optionally, a combination of an orthographic projection of the recess-forming layer 40 on the base substrate 10 and an orthographic projection of one of the plurality of second electrode blocks 30w on the base substrate 10 substantially covers an orthographic projection of one of the plurality of first electrode blocks 20w on the base substrate 10. Optionally, a combination of an orthographic projection of the recess-forming layer 40 on the base substrate 10 and an orthographic projection of one of the plurality of fourth electrode blocks 30c on the base substrate 10 substantially covers an orthographic projection of one of the plurality of third electrode blocks 20c on the base substrate 10. Optionally, a combination of an orthographic projection of the recess-forming layer 40 on the base substrate 10 and an orthographic projection of one of the plurality of sixth electrode blocks 30r on the base substrate 10 substantially covers an orthographic projection of one of the plurality of fifth electrode blocks 20r on the base substrate 10.

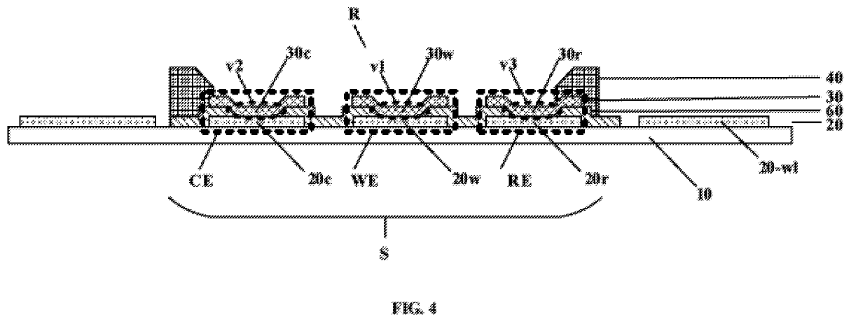

FIG. 4 is a cross-sectional view of a fluid sample analysis chip is some embodiments according to the present disclosure (along A-A′ line in FIG. 2). Referring to FIG. 4, the fluid sample analysis chip in some embodiments further includes a protective layer 60 between the first electrode layer 20 and the second electrode layer 30. A surface of the plurality of first electrode blocks 20w facing away the base substrate 10 is substantially covered by a combination of the second electrode layer 30 and the protective layer 60. Optionally, a surface of the plurality of third electrode blocks 20c facing away the base substrate 10 is substantially covered by a combination of the second electrode layer 30 and the protective layer 60. Optionally, a surface of the plurality of fifth electrode blocks 20r facing away the base substrate 10 is substantially covered by a combination of the second electrode layer 30 and the protective layer 60. Optionally, a combination of an orthographic projection of the protective layer 60 on the base substrate 10 and an orthographic projection of the second electrode layer 30 on the base substrate 10 substantially covers an orthographic projection of the first electrode layer 20 an the base substrate 10. Optionally, a combination of an orthographic projection of the protective layer 60 on the base substrate 10 and an orthographic projection of one of the plurality of second electrode blocks 30w on the base substrate 10 substantially covers an orthographic projection of one of the plurality of first electrode blocks 20w on the base substrate 10. Optionally, a combination of an orthographic projection of the protective layer 60 on the base substrate 10 and an orthographic projection of one of the plurality of fourth electrode blocks 30c on the base substrate 10 substantially covers an orthographic projection of one of the plurality of third electrode blocks 20c on the base substrate 10. Optionally, a combination of an orthographic projection of the protective layer 60 on the base substrate 10 and an orthographic projection of one of the plurality of sixth electrode blocks 30r on the base substrate 10 substantially covers an orthographic projection of one of the plurality of fifth electrode blocks 20r on the base substrate 10.

In some embodiments, one of the plurality of first electrode blocks 20w and one of the plurality of second electrode blocks 30w in the working electrode WE are electrically connected to each other through a first via v1 extending through the protective layer 60. Optionally, one of the plurality of third electrode blocks 20c and one of the plurality of fourth electrode blocks 30c is the counter electrode CE are electrically connected to each other through a second via v2 extending through the protective layer 60. Optionally, one of the plurality of fifth electrode blocks 20r and one of the plurality of sixth electrode blocks 30r in the reference electrode RE are electrically connected to each other through a third via v3 extending through the protective layer 60.

Various appropriate materials and various appropriate fabricating methods may be used for making the protective layer 60. For example, an electrically insulating and corrosion-resistant material may be used for making the protective layer 60. For example, an insulating material may be deposited on the substrate by a plasma-enhanced chemical vapor deposition (PECVD) process. Examples of appropriate insulating and corrosion-resistant materials include, but are not limited to, polyimide, silicon oxide (SiO_{y}), silicon nitride (SiN_{y}, e.g., Si₃N₄), and silicon oxynitride (SiOₓN_{y}).

Various appropriate conductive materials and various appropriate fabricating methods may be used for making the second electrode layer 30. As discussed above, the second electrode layer 30 is made of a corrosion-resistant, non-metal conductive material, e.g., an acid-resistant, non-metal conductive material. In some embodiments, the second electrode layer 30 is made of a semiconductor material, e.g., an acid-resistant conductive semiconductor material. Optionally, the second electrode layer 30 is made of an N'0 doped semiconductor material such as an N+ doped silicon. Other examples of appropriate conductive materials for making the second electrode layer 30 include an N+ doped silicon germanium. Optionally, the second electrode layer 30 is made of a P+ doped semiconductor material such as a P+ doped silicon. The corrosion-resistant, non-metal conductive material may be deposited on the substrate by a plasma-enhanced chemical vapor deposition (PECVD) process. Optionally, the second electrode layer 30 has a doping concentration in a range of approximately 1×10¹² atom/cm³ to approximately 1×10²¹ atom/cm⁵, e.g., approximately 1×10¹² atom/cm³ to approximately 1×10¹³ atom/cm³, approximately 1×10¹³ atom/cm⁵ to approximately 1×10⁴ atom/cm³, approximately 1×10¹⁴ atom/cm³ to approximately 1×10¹⁵ atom/cm³, approximately 1×10¹⁵ atom/cm³ to approximately 1×10¹⁶ atom/cm³, approximately 1×10¹⁶ atom/cm³ to approximately 1×10¹⁷ atom/cm³, approximately 1×10¹⁷ atom/cm³ to approximately 1×10¹⁸ atom/cm³, approximately 1×10¹⁸ atom/cm⁵ to approximately 1×10¹⁹ atom/cm³, approximately 1×10¹⁹ atom/cm³ to approximately 1×10²⁰ atom/cm³, and approximately 1×10²⁰ atom/cm⁵ to approximately 1×10²¹ atom/cm³. Optionally, the second electrode layer 30 has a doping concentration in a range of approximately 1×10¹⁷ atom/cm³ to approximately 11×10²¹ atom/cm³.

Optionally, the N+ doped semiconductor material is an N+ doped amorphous semiconductor material, e.g., an N+ doped amorphous silicon. Optionally, the N+ doped semiconductor material is an N+ doped polycrystalline semiconductor material, e.g., an N+ doped polycrystalline silicon. Optionally, the N+ doped semiconductor material has a resistivity of about 10000 Ω·cm or lower, e.g., about 9000 Ω·cm or lower, about 8000 Ω·cm or lower, about 7000 Ω·cm or lower, about 6000 Ω·cm or lower, about 5000 Ω·cm or lower, about 4000 Ω·cm or lower, about 3000 Ω·cm or lower, about 2000 Ω·cm or lower, about 1000 Ω·cm or lower, about 750 Ω·cm or lower, about 500 Ω·cm or lower, about 250 Ω·cm or lower, about 100 Ω·cm or lower, about 75 Ω·cm or lower, about 50 Ω·cm or lower, about 25 Ω·cm or lower, about 10 Ω·cm or lows, about 7.5 Ω·cm or lower, about 5 Ω·cm or lower, about 2.5 Ω·cm or lower, and about 1 Ω·cm or lower.

Various appropriate dopants may be used for making the second electrode layer. In some embodiments, the dopant is an N-type dopant such as a Group VA element of the Periodic Table of the Elements including nitrogen (N), phosphorous (P), arsenic (As), antimony (Sb), and bismuth (Bi). Optionally, the dopant is phosphor. Optionally, the dopant is boron. In some embodiments, the dopant is a P-type dopant such as a Group IIIA element of the Periodic Table of the Elements including boron (B), aluminum (Al), gallium (Ga), indium (In), and thallium (TI).

Various appropriate conductive materials and various appropriate fabricating methods may be used for making the first electrode layer 20. For example, a conductive material may be deposited on the substrate, e.g., by sputtering or vapor deposition or solution coating, and patterned. Because the surface of the first electrode layer 20 is substantially unexposed in the present fluid sample analysis chip, a wide selection of conductive materials may be used, including materials having high conductivity. Examples of appropriate conductive materials include metals and semiconductor materials such as metal oxides. Examples of appropriate metals for making the first electrode layer 20 includes aluminum and copper. Examples of appropriate metal oxides for making the first electrode layer 20 includes indium tin oxide indium gallium tm oxide.

Optionally, the first electrode layer 20 is made of indium tin oxide, and the second electrode layer 30 is made of an N+ doped silicon.

Referring to FIGs 1 to 4, the fluid sample analysis chip in some embodiments further includes a plurality of first signal lines 20-wl and a plurality of first contact pads 20-wp. Each of the plurality of first signal lines 20-wl electrically connects the working electrode WE in one of the plurality of sensors S to one of the plurality of first contact pads 20-wp. For example, each of the plurality of first signal lines 20-wl electrically connects one of the plurality of first electrode blocks 20w in one of the plurality of sensors S to one of the plurality of first contact pads 20-wp. Optionally, the plurality of first signal lines 20-wl and the plurality of first electrode blocks 20w are in a same layer and made of a same material in a same patterning process and using a same mask plate. Thus, in some embodiment, the first electrode layer 20 includes the plurality of first electrode blocks 20w and the plurality of first signal lines 20-wl. Optionally, the plurality of first signal lines 20-wl, the plurality of first electrode blocks 20w, and the plurality of first contact pads 20-wp are in a same layer and made of a same material in a same patterning process and using a same mask plate. Thus, in some embodiments, the first electrode layer 20 includes the plurality of first electrode blocks 20w, the plurality of first signal lines 20-wl, and the plurality of first contact pads 20-wp.

As used herein, the term “same layer” refers to the relationship between the layers simultaneously formed in the same step. In one example, the plurality of first signal lines 20-wl and the plurality of first electrode blocks 20w are in a same layer when they are formed as a result of one or more steps of a same patterning process performed in a same layer of material. In another example, the plurality of first signal lines 20-wl and the plurality of first electrode blocks 20w can be formed in a same layer by simultaneously performing the step of forming the plurality of first signal lines 20-wl and the step of forming the plurality of first electrode blocks 20w. The term “same layer” does not always mean that the thickness of the layer or the height of the layer in a cross-sectional view is the same.

Referring to FIG. 2, the fluid sample analysis chip in some embodiments further includes a plurality of second signal lines 20-cl and a plurality of second contact pads 20-cp. Each of the plurality of second signal lines 20-cl electrically connects the counter electrode CE in one of the plurality of sensors S to one of the plurality of second contact pads 20-cp. For example, each of the plurality of second signal lines 20-cl electrically connects one of the plurality of third electrode blocks 20c in one of the plurality of sensors S to one of the plurality of second contact pads 20-cp. Optionally, the plurality of second signal lines 20-cl and the plurality of first electrode blocks 20w are in a same layer and made of a same material in a same patterning process and using a same mask plate. Thus, in some embodiments, the first electrode layer 20 includes the plurality of first electrode blocks 20w, the plurality of third electrode blocks 20c, the plurality of first signal lines 20-wl, and the plurality of second signal lines 20-cl. Optionally, the plurality of second signal lines 20-cl, the plurality of first electrode blocks 20w, and the plurality of second contact pads 20-cp are in a same layer and made of a same material in a same patterning process and using a same mask plate. Thus, in some embodiments, the first electrode layer 20 includes the plurality of first electrode blocks 20w, the plurality of third electrode blocks 20c, the plurality of first signal hues 20-wl, the plurality of second signal lines 20-cl, the plurality of first contact pads 20-wp, and the plurality of second contact pads 20-cp.

Referring to FIG. 2, the fluid sample analysis chip in some embodiments further includes a plurality of third signal lines 20-rl and a plurality of third contact pads 20-rp. Each of the plurality of third signal lines 20-rl electrically connects the reference electrode RE in one of the plurality of sensors S to one of the plurality of third contact pads 20-rp. For example, each of the plurality of third signal lines 20-rl electrically connects one of the plurality of fifth electrode blocks 20r in one of the plurality of sensors S to one of the plurality of third contact pads 20-rp. Optionally, the plurality of third signal lines 20-rl and the plurality of first electrode blocks 20w are in a same layer and made of a same material in a same patterning process and using a same mask plate. Thus, in some embodiments, the first electrode layer 20 includes the plurality of first electrode blocks 20w, the plurality of third electrode blocks 20c, the plurality of fifth electrode blocks 20r, the plurality of first signal lines 20-wl, the plurality of second signal lines 20-cl, and the plurality of third signal lines 20-rl. Optionally, the plurality of third signal lines 20-rl the plurality of first electrode blocks 20w, and the plurality of third contact pads 20-rp are in a same layer and made of a same material in a same patterning process and using a same mask plate. Thus, in some embodiments, the first electrode layer 20 includes the plurality of first electrode blocks 20w, the plurality of third electrode blocks 20c, the plurality of fifth electrode blocks 20r, the plurality of first signal lines 20-wl, the plurality of second signal lines 20-cl, the plurality of third signal lines 20-rl, the plurality of first contact pads 20-wp, the plurality of second contact pads 20-cp, and the plurality of third contact pads 20-rp.

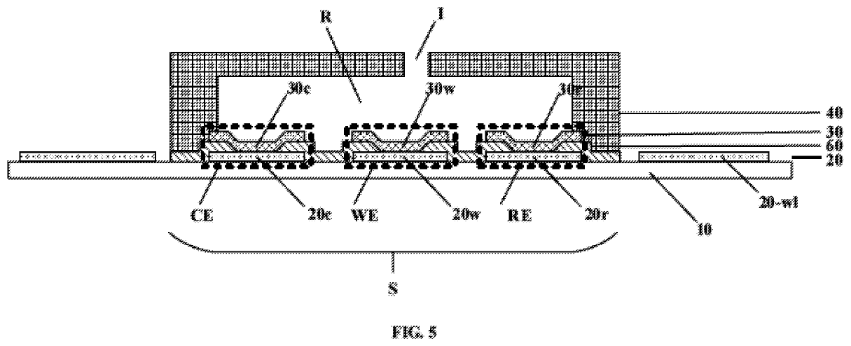

FIG. 5 is a cross-sectional view of a fluid sample analysis chip in some embodiments according to the present disclosure. Referring to FIG 5 the plurality of recesses R in the fluid sample analysis chip in some embodiments are a plurality of chambers. In one example, the fluid sample can be injected or otherwise introduced into the plurality of recesses R through a plurality of inlets I, respectively

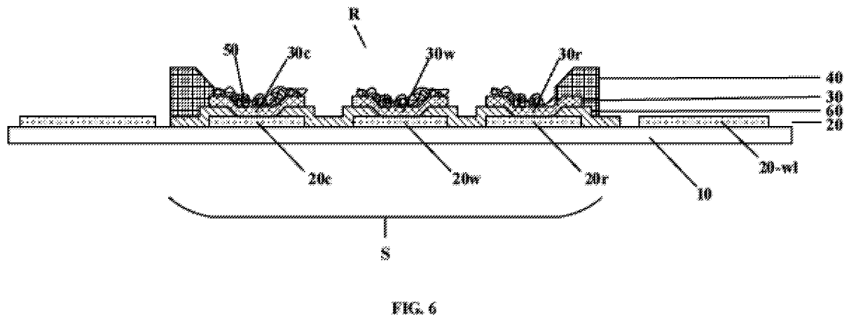

FIG. 6 is a cross-sectional view of a fluid sample analysis chip in some embodiments according to the present disclosure. Referring to FIG. 6, the fluid sample analysis chip in some embodiments further includes a conductive polymer layer 50 on a side of the second electrode layer 30 facing away the first electrode layer 20. The conductive polymer layer 50 at least partially covers a surface of the each of the plurality of second electrode blocks 30w. Optionally, the conductive polymer layer 50 at least partially covers a surface of the each of the plurality of fourth electrode blocks 30c. Optionally, the conductive polymer layer 50 at least partially covers a surface of the each of the plurality of sixth electrode blocks 30r.

Various appropriate conductive polymers may be used for making the conductive polymer layer 50. Examples of appropriate conductive polymers for making the conductive polymer layer 50 include polypyrroles, polyanilines, polyacetylenes, polyphenylenevinylenes, polythiophenes and the like. Optionally, the conductive polymer is coated on the surface of the second electrode layer 30 facing away the first electrode layer 20, e.g., on the surfaces of the plurality of second electrode blocks 30w. Optionally, the conductive polymer layer 50 is embedded or functionalized with one or more capture probes which binds to one or more markers.

In another aspect, the present disclosure provides a method of fabricating a fluid sample analysis chip. In some embodiments, the method includes forming a first electrode layer on a base substrate and the first electrode layer formed to include a plurality of first electrode blocks spaced apart from each other; forming a second electrode layer on a side of the first electrode layer facing away the base substrate, the second electrode layer formed to include a plurality of second electrode blocks spaced apart from each other. Each of the plurality of second electrode blocks formed to be electrically connected to one of the plurality of first electrode blocks. The fluid sample analysis chip is formed to include a plurality of sensors. Each of the plurality of sensors ts formed to include a working electrode. The walking electrode is formed to include one of the plurality of first electrode blocks and one of the plurality of second electrode blocks electrically connected to each other.

In some embodiments, the first electrode layer and the second electrode layer are formed so that a surface of the plurality of first electrode blocks facing away the base substrate is substantially covered by the second electrode layer. Optionally, the first electrode layer and the second electrode layer are formed so that an orthographic projection of the second electrode layer on the base substrate substantially covers an orthographic projection of the first electrode layer on the base substrate.

In some embodiments, the step of forming the second electrode layer includes forming a semiconductor material layer, followed by doping the semiconductor material layer to form a doped semiconductor material layer, e.g., a N+ doped semiconductor material layer.

In some embodiments, the method farther includes forming a protective layer between the first electrode layer and the second electrode layer. The one of the plurality of first electrode blocks and the one of the plurality of second electrode blocks in the working electrode are electrically connected to each other through a first via extending through the protective layer. Optionally, the protective layer, the first electrode layer, and the second electrode layer are formed so that a surface of the plurality of first electrode blocks facing away the base substrate is substantially covered by the second electrode layer and the protective layer. Optionally, a combination of an orthographic projection of the protective layer on the base substrate and an orthographic projection of the second electrode layer on the base substrate substantially covers an orthographic projection of the first electrode layer on the base substrate.

In some embodiments, the method further includes forming a recess-forming layer on a side of the second electrode layer facing away the first electrode layer, and forming a plurality of recesses extending through the recess-forming layer, exposing at least a portion of each of the plurality of second electrode blocks. Optionally, each of the plurality of recesses is formed to hold an analyte (e.g., a fluid sample).

In some embodiments, the method further includes forming a conductive polymer layer at least partially covering a surface of each of the plurality of second electrode blocks.

In some embodiments, the method further includes forming a plurality of first signal lines and forming a plurality of first contact pads. Optionally, each of the plurality of first signal lines is formed to electrically connect the working electrode in one of the plurality of sensors to one of the plurality of first contact pads.

In some embodiments the plurality of first signal lanes and the plurality of first electrode blocks are formed in a same layer using a same material and a same mask plate in a same patterning process.

In some embodiments, forming the first electrode layer further includes forming a plurality of third electrode blocks spaced apart from each other; and forming the second electrode layer further includes forming a plurality of fourth electrode blocks spaced apart from each other. Optionally, each of the plurality of sensors is formed to further include a counter electrode. The counter electrode is formed to include one of the plurality of third electrode blocks and one of the plurality of fourth electrode blocks electrically connected to each other.

In some embodiments, forming the first electrode layer further includes forming a plurality of fifth electrode blocks spaced apart from each other; and forming the second electrode layer further includes forming a plurality of sixth electrode blocks spaced apart from each other. Optionally, each of the plurality of sensors is formed to further include a reference electrode. The reference electrode is formed to include one of the plurality of fifth electrode blocks and one of the plurality of sixth electrode blocks electrically connected to each other.

Optionally, the working electrode is formed between the reference electrode and the counter electrode, with the reference electrode spaced apart from the working electrode, and the counter electrode spaced apart from the working electrode.

In some embodiments, the method further includes forming a plurality of second signal lines and forming a plurality of second contact pads. Optionally, each of the plurality of second signal lines is formed to electrically connect the counter electrode in one of the plurality of sensors to one of the plurality of second contact pads. In some embodiments, the method further includes forming a plurality of third signal lines and forming a plurality of third contact pads. Optionally, each of the plurality of third signal lines is formed to electrically connect the reference electrode in one of the plurality of sensors to one of the plurality of third contact pads.

In some embodiments, the plurality of first signal lines, the plurality of second signal lines, the plurality of third signal lines, and the plurality of first electrode blocks are in a same layer using a same material and a same mask plate in a same patterning process.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. In is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment and the reference to exemplary embodiments of the invention does not imply a limitation on the invention, and no such imitation, is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A sample analysis chip, comprising:
a base substrate; and
a working electrode;
wherein the working electrode has a double-layer structure;
wherein the double-layer structure comprises a first electrode layer on the base substrate, and a second electrode layer on a side of the first electrode layer facing away the base substrate; wherein the second electrode layer comprises a corrosion-resistant, non-metal conductive material; and
wherein a material of the first electrode layer and a material of the second electrode layer are different from each other.

2. The sample analysis chip of claim 1, wherein an orthographic projection of the second electrode layer on the base substrate substantially covers an orthographic projection of the first electrode layer on the base substrate.

3. The sample analysis chip of claim 1, wherein the material of the second electrode layer comprises a semiconductor material.

4. The sample analysis chip of claim 1, wherein the material of the first electrode layer comprises a semiconductor material.

5. The sample analysis chip of claim 1, further comprising a protective layer between the first electrode layer and the second electrode layer.

6. The sample analysis chip of claim 4, wherein the first electrode layer are electrically connected to the second electrode layer through a first via extending through the protective layer.

7. The sample analysis chip of claim 1, wherein the second electrode layer comprises an acid-resistant conductive semiconductor material.

8. The sample analysis chip of claim 1, wherein the second electrode layer comprises an N+doped semiconductor material.

9. The sample analysis chip of claim 1, wherein the first electrode layer comprises a metal oxide material.

10. The sample analysis chip of claim 1, wherein the first electrode layer comprises indium tin oxide, and the second electrode layer comprises an N+ doped silicon.

11. The sample analysis chip of claim 1, further comprising a recess-forming layer on a side of the second electrode layer facing away the first electrode layer;
wherein the sample analysis chip has a plurality of recesses extending through the recess-forming layer, each of which exposing at least a portion of the second electrode layer; and
each of the plurality of recesses configured to hold an analyte.

12. The sample analysis chip of claim 1, further comprising a conductive polymer layer at least partially covering a surface of the second electrode layer.

13. The sample analysis chip of claim 1, further comprising a plurality of first signal lines and a plurality of first contact pads;
wherein one of the plurality of first signal lines electrically connects the working electrode to one of the plurality of first contact pads.

14. The sample analysis chip of claim 13, wherein the plurality of first signal lines and the first electrode layer are in a same layer and comprise a same material.

15. The sample analysis chip of claim 1, further comprising a counter electrode;
wherein the counter electrode has the double-layer structure.

16. The sample analysis chip of claim 1, further comprising a reference electrode;
wherein the reference electrode has the double-layer structure.

17. The sample analysis chip of claim 1, further comprising a counter electrode and a reference electrode;
wherein the counter electrode has the double-layer structure;
the reference electrode has the double-layer structure; and
the working electrode is between the reference electrode and the counter electrode, with the reference electrode spaced apart from the working electrode, and the counter electrode spaced apart from the working electrode.

18. The sample analysis chip of claim 17, further comprising:
a plurality of first signal lines;
a plurality of first contact pads;
a plurality of second signal lines;
a plurality of second contact pads;
a plurality of third signal lines; and
a plurality of third contact pads;
wherein one of the plurality of first signal lines electrically connects the working electrode to one of the plurality of first contact pads;
one of the plurality of second signal lines electrically connects the counter electrode to one of the plurality of second contact pads; and
one of the plurality of third signal lines electrically connects the reference electrode to one of the plurality of third contact pads.

19. The sample analysis chip of claim 18, wherein the plurality of first signal lines, the plurality of second signal lines, the plurality of third signal lines, and the first electrode layer are in a same layer and comprise a same material.

20. A method of fabricating a sample analysis chip, comprising:
forming a working electrode on a base substrate;
wherein the working electrode is formed to have a double-layer structure;
wherein the double-layer structure is formed to have a first electrode layer on a base substrate, and a second electrode layer on a side of the first electrode layer facing away the base substrate;
wherein the second electrode layer is made of a corrosion-resistant, non-metal conductive material; and
a material of the first electrode layer and a material of the second electrode layer are different from each other.
